(19) United States
(12) Patent Application Publication
(10) Pub. No.: US 2011/0087676 A1
(43) Pub. Date: Apr. 14, 2011

(54) Communication system, server and method

(76) Inventor: Hermann Geupel, Munich (DE)

(21) Appl. No.: 12/587,786

(22) Filed: Oct. 13, 2009

(51) Int. Cl. G06F 17/30

(52) U.S. Cl. 707/749; 707/E17.084

(57) ABSTRACT

A communication server comprises a database for storing a plurality of sets of information provider terminal data, each set representing a respective information provider terminal and comprising score data indicative of scores alloted to information previously received from the respective information provider terminal. The communication server presents to an information receiver terminal at least one set of information provider terminal data, selects, in accordance with a selection process of the information receiver terminal, one of the sets of information provider terminal data presented, receives from the information receiver terminal a specific query for information from the information provider terminal represented by the selected set of information provider terminal data, transmits, to the information receiver terminal, a specific information relating to the specific query, and updates the score data in the selected set of information provider terminal data using a score alloted by the information receiver terminal to the specific information.

### BACKGROUND OF THE INVENTION

1. Field of the Invention

The present invention relates to the field of transmitting data via a network. In particular, present invention relates to a communication system, a communication server and a communication server method.

2. The Prior Art

To acquire specific information, communication via computer networks, particularly the Internet, is common practice. However, if information is sought to answer an individual question, common ways of communicating over the Internet are limited. Conventionally, published literature excerpts or formerly exchanged chat discussions on similar topics are used or questions are posted in chat forums. There is a vast number of communication servers providing information in the above manner, wherein such services are usually offered free of charge or only charging small amounts, e.g. by way of subscription fees.

Though Internet platforms that offer paid consulting service via the platform respective platform exist, they appear to be very rare and are, for the most part, economically not very successful. This is due to the problem that the provider of information, such as a consultant or trained expert, irrevocably delivers his service, namely supplies requested information, before the receiver of the respective information is in the position to assess, whether the supplied information actually is useful for the receiver. In commercial consulting over the internet, the customer is required to provide pre-payment or bindingly obligate himself to later payment before he can assess the value of the later received information. For a commercial consulting service to work, it is thus necessary that potential customers have confidence that information offered by a particular information provider will indeed be useful to the respective customer. Since it is well known that the Internet is utilized not only by respectable market actors but also by untrustworthy subjects making use of the high degree of anonymity maintainable in internet commerce, such confidence often is lacked thus limiting the turnover of commercial information providing platforms.

Frequently, professional articles and literature are offered for chargeable download. However, such information is not tailored to an individual question as it has been written and stored in advance, prior to the time when a particular question may arise.

### SUMMARY OF THE INVENTION

In view of the problems described above, it is an object of the present invention to improve the handling of information queries and responses to information queries in communication networks.

In order to accomplish the above object, the present invention provides, according to one aspect thereof, a communication system comprising a network and connected thereto a plurality of information receiver terminals, a plurality of information provider terminals, and a server. The server comprises means for receiving information from the information provider terminals, a database storing sets of information provider terminal data, wherein each set of information provider terminal data represents a respective information provider terminal among the plurality of information provider terminals and includes score data indicative of scores alloted, by individual ones of the plurality of information receiver terminals, to information previously received from the respective information provider terminal, and presenting means for presenting to the information receiver terminals at least one of the sets of information provider terminal data. The information provider terminals each comprise means for transmitting, via the network, information to the server. The information receiver terminals each comprise inquiring means for selecting in the server, via the network, a set of information provider terminal data among the sets of information provider terminal data presented and transmitting, via said network, to the server a specific query for information from the information provider terminal represented by the selected set of information provider terminal data, receiving means for receiving, via the network, from the server a specific information relating to the specific query, and scoring means for allotting a score to the specific information and transmitting the score to the server. The server further comprises means for transmitting the specific information to the information receiver terminal having transmitted the specific query, and means for updating the score data in the selected set of information provider terminal data using the score alloted to the specific information.

Thus, the users of information receiver terminals RT seeking a specific information will be able to select an information provider terminal PT for a specific query depending on the score the respective information provider terminal PT has previously received.

According to a preferred embodiment, the server further comprises means for forwarding the specific query to the information provider terminal represented by the selected set of information provider terminal data, and the information provider terminals further comprise means for receiving queries from the server.

According to another preferred embodiment, the server, after having transmitted, to an individual one among the plurality of information receiver terminals, a specific information relating to a specific query transmitted by the individual information receiver terminal, requires the individual information receiver terminal to transmit the score allotted to the specific information, before allowing another specific information to be transmitted to the individual information receiver terminal.

According to another preferred embodiment, the database further stores sets of information receiver terminal data, wherein each set of information receiver terminal data represents a respective information receiver terminal among the plurality of information receiver terminals, and the presenting means are further adapted to present to the information provider terminals at least one of the sets of information receiver terminal data.

In this embodiment, the information receiver terminals preferably comprise upload means for uploading, via the network, data to the server, and the server preferably is adapted to selectively allow upload of data from an individual one among the plurality of information receiver terminals in order to modify the respective set of information receiver terminal data representing the individual information receiver terminal.

Further preferably, in this embodiment, the communication system comprises at least one service terminal connected to the network. In this preferred variant, the service terminal comprises means for processing receiver terminal data. Also in this preferred variant, the database further stores at least one set of service terminal data, each set of service terminal data representing a respective one of the at least one service terminals, the presenting means is further adapted for presenting, to the information receiver terminals, at least one of the sets of service terminal data. Further, in this preferred variant, the server further comprises means for allowing an individual one among the plurality of information receiver terminals to select a set of service terminal data from the presented sets of service terminal data, means for receiving from the individual information receiver terminal a specific service request, means for forwarding the specific service request to the service terminal represented by the selected set of service terminal data, and the server is further adapted to allow the service terminal represented by the selected set of service terminal data to process, according to the specific service request, data in the set of information receiver terminal data representing the individual information receiver terminal.

According to another preferred embodiment, the server comprises access management means for allowing, controlling and denying connections between the information receiver terminals and the server and between the information providing terminals and the server.

Preferably, in this embodiment, the server is adapted to selectively forward, via the network, messages from the information provider terminals to the information receiver terminals and from the information receiver terminals to the information provider terminals.

According to another preferred embodiment, each the said server, the information receiver terminals and the information provider terminals comprise encryption means and decryption means for allowing encrypted data transfer between the server and the information receiver terminals and between the server and the information provider terminals.

According to yet another preferred embodiment, the server comprises payment processing means for processing payments received from clients associated with information receiver terminals having received information from the server.

According to another aspect of the present invention, the above-mentioned object is accomplished by a communication server comprising means for receiving information from information provider terminals, a database for storing a plurality of sets of information provider terminal data, each set of information provider terminal data representing a respective information provider terminal and comprising score data indicative of scores alloted to information previously received from the respective information provider terminal, means for presenting, via a network, to an information receiver terminal at least one set of the plurality of sets of information provider terminal data, means for selecting, in accordance with a selection process of the information receiver terminal, a set of information provider terminal data among the sets of information provider terminal data presented, means for receiving, via the network, from the information receiver terminal a specific query for information from the information provider terminal represented by the selected set of information provider terminal data, means for transmitting, to the information receiver terminal, a specific information relating to the specific query, and means for updating the score data in the selected set of information provider terminal data using a score alloted by the information receiver terminal to the specific information.

According to a preferred embodiment, the server further comprises means for forwarding the specific query to the information provider terminal represented by the selected set of information provider terminal data.

According to another preferred embodiment, the database further stores information receiver terminal data representing the information receiver terminal, and the presenting means are further adapted to present to the information provider terminals the information receiver terminal data.

Preferably in this embodiment, the server is adapted to selectively allow upload of data from the information receiver terminal in order to modify the receiver terminal data representing the information receiver terminal.

According to another preferred embodiment, the database further stores at least one set of service terminal data, each set of service terminal data representing a respective service terminal, and the presenting means is further adapted for presenting, to the information receiver terminal, at least one of said sets of service terminal data. In this preferred variant, the server further comprises means for allowing the information receiver terminal to select a set of service terminal data from the presented sets of service terminal data, means for receiving from the information receiver terminal a specific service request, means for forwarding the specific service request to the service terminal represented by the selected set of service terminal data. Therein, the server is further adapted to allow the service terminal represented by the selected set of service terminal data to process, according to the specific service request, the receiver terminal data representing the information receiver terminal.

According to another preferred embodiment, the server comprises access management means for allowing, controlling and denying connections between the information receiver terminal and the server and between the information providing terminals and the server.

Preferably in this embodiment, the server is adapted to selectively forward, via the network, messages from the information provider terminals to the information receiver terminal and from the information receiver terminal to the information provider terminal.

According to another preferred embodiment, the server comprises encryption means and decryption means for allowing encrypted data transfer between the server and the information receiver terminal and between the server and the information provider terminals.

According to yet another preferred embodiment, the server comprises payment processing means for processing payments received from a client associated with the information receiver terminal.

According to another aspect of the present invention, the above-mentioned object is accomplished by providing a communication server method comprising a step of receiving information from an information provider terminal, a step of presenting, via a network, to an information receiver terminal at least one set of information provider terminal data representing a respective information provider terminal and comprising score data indicative of scores alloted to information previously received from the respective information provider terminal, and a step of selecting, in accordance with a selection process of the information receiver terminal, a set of information provider terminal data among said sets of information provider terminal data presented. The method further comprises a step of receiving, via the network, from the information receiver terminal a specific query for information from the information provider terminal represented by the selected set of information provider terminal data, and a step of transmitting, to the information receiver terminal, a specific information relating to said specific query. The method further comprises a step of updating the score data in said selected set of information provider terminal data using a score alloted by the information receiver terminal to the specific information.

Preferably, the communication method further comprises a step of forwarding the specific query to the information provider terminal represented by the selected set of information provider terminal data, wherein the step of receiving information from an information provider terminal includes receiving the specific information in response to the step of forwarding the specific query to the information provider terminal represented by the selected set of information provider terminal data.

According to another preferred embodiment, information receiver terminal data representing the information receiver terminal are stored in the database, and the method further comprises a step of presenting to the information provider terminals the information receiver terminal data.

Preferably in this embodiment, the method further comprises a step of allowing upload of data from the information receiver terminal in order to modify the receiver terminal data representing the information receiver terminal.

According to another preferred embodiment, at least one set of service terminal data are stored in the database, each set of service terminal data representing a respective service terminal, and the method further comprises a step of presenting, to the information receiver terminal, at least one of said sets of service terminal data. In this preferred variant, the information receiver terminal is allowed to select a set of service terminal data from the presented sets of service terminal data, a specific service request is received from the information receiver terminal, and the specific service request is forwarded to the service terminal represented by the selected set of service terminal data. Therein, the service terminal represented by the selected set of service terminal data is allowed to process, according to the specific service request, the receiver terminal data representing the information receiver terminal.

According to another preferred embodiment, data transfer between the server and the information receiver terminal and between the server and the information provider terminal is encrypted for transmission and decrypted after respective transmission.

According to yet another preferred embodiment, the method comprises a step of processing a payment received from a client associated with the information receiver terminal.

Fundamentally, any variant of the invention described or indicated within the scope of the present application can be particularly advantageous, depending on the economic and technical conditions in an individual case. Unless something to the contrary is stated, and to the extent that this can fundamentally be implemented technically, individual characteristics of the embodiments described can be interchanged or combined with one another.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

FIG. 1 schematically shows the general setup of a communication system according to the present invention.

FIG. 2 is a block diagram showing an exemplary general hardware setup of a portal server embodying a communication server according to the present invention.

FIG. 3 is a flow chart illustrating a communication server method according to the present invention.

FIG. 4 is a schematic view of a screen layout according to one embodiment of the invention.

FIG. 5 is a schematic view of another screen layout according to one embodiment of the invention.

FIG. 6 is a schematic view of an information rating screen for inputting a score according to one embodiment of the invention.

FIG. 7 is a schematic view of information provider terminal data displayed in a rating list according to one embodiment of the invention.

### DETAILED DESCRIPTION OF PREFERRED EMBODIMENTS

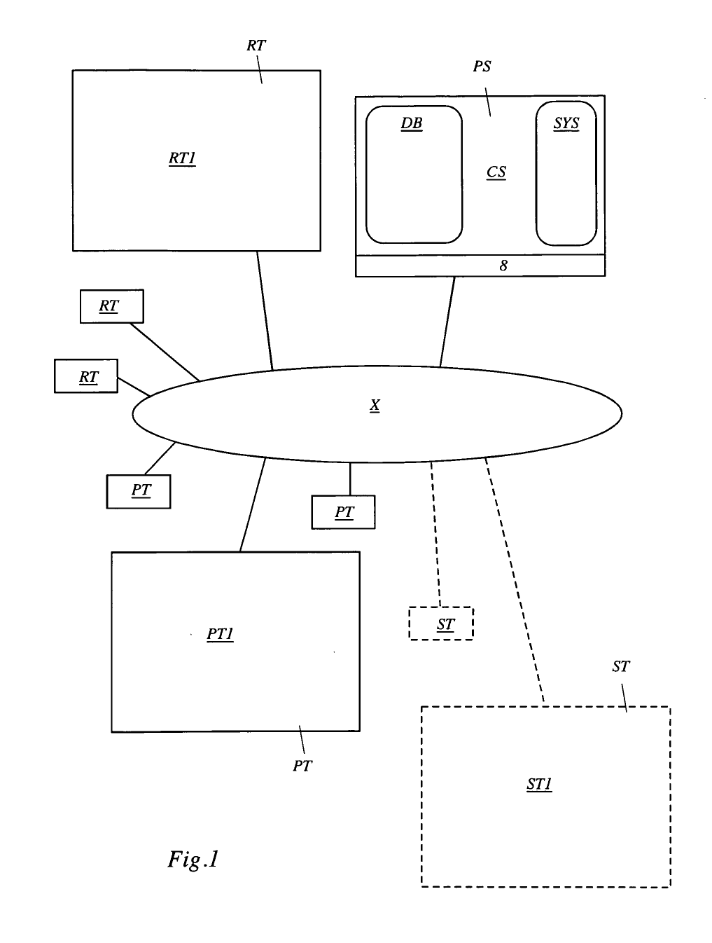

The communication system depicted in FIG. 1 comprises a network X and, connected thereto, information receiver terminals RT, information provider terminals PT, a communication server PS hosting an information portal and referred to hereinafter as portal server PS, and, optionally, service terminals ST. Though only few terminals RT, PT and PS are shown, a large number of terminals may connect to the portal server PS via the network X. As typically the case in the Internet, the number of terminals RT, PT and PS connecting to the portal server PS may vary over time.

The portal server PS implementation is based on a computer system CS like or similar to standard server computer systems known per se from the prior art and comprises a database DB storing sets of information provider terminal data, wherein each set of information provider terminal data represents a respective information provider terminal PT. The information provider terminal data includes score data indicative of scores alloted, by individual ones of the information receiver terminals RT, to information previously received from the respective information provider terminal.

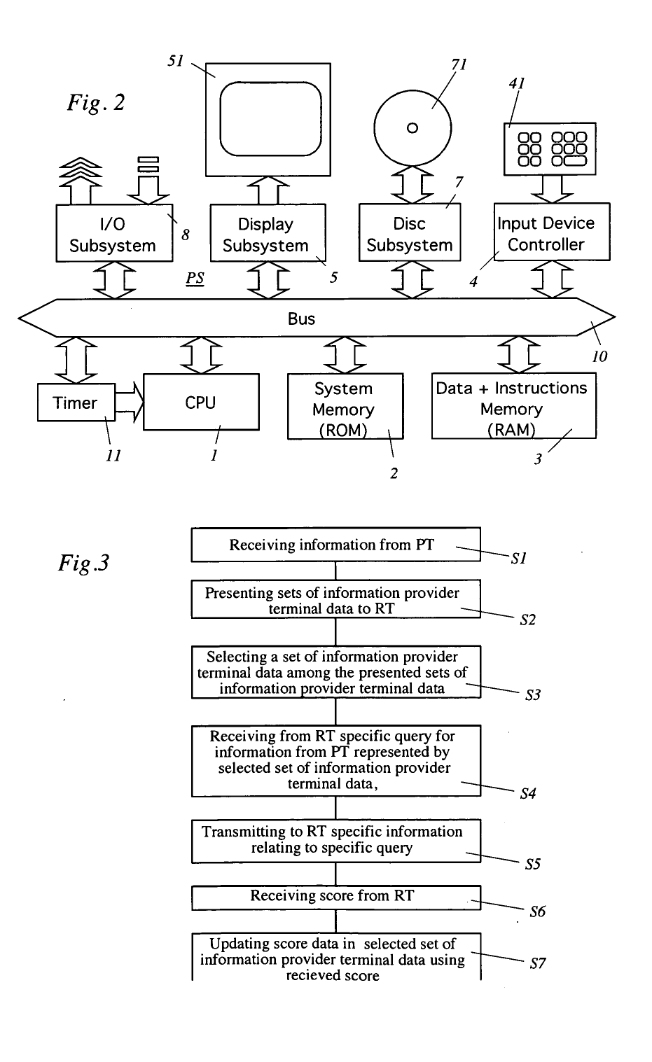

Generally, the hardware of the communication server according to the present invention can be similar to conventional server hardware known in the art. Now, with reference to FIG. 2, a description will be made about an exemplary general hardware setup of the portal server PS shown in FIG. 1. The portal server PS is controlled by a microcomputer comprising a microprocessor unit (CPU) 1, a read-only memory (ROM) 2 serving as a system memory and a random-access memory (RAM) 3 serving as a data and instructions memory. The CPU 1 controls all operations of the portal server PS. To the CPU 1 is connected, via a data and address bus 10, the ROM 2, RAM 3, Input device controller 4, which may be linked to a keyboard 41, mouse (not shown) or similar input equipment, display subsystem 5, disc subsystem 7 controlling a storage device 71, and an input/output subsystem implementing a communication interface 8 such as a usual network interface per se known from the prior art. Also connected to the CPU 1 is a timer 11 for counting various time periods, for example, to signal interrupt timing for timer interrupt processing.

The ROM 2 has prestored therein various firmware programs to be executed by the CPU 1 and various data to be referred to by the CPU 1. The RAM 3 is used as a working memory for storing various data generated as the CPU 1 executes the programs. The RAM 3 is also used as a memory for storing the currently-executed program and data related thereto. Predetermined address regions of the RAM 3 are allocated to various functions and used as registers, flags, tables, memories, etc. The keyboard 41 is in the form of a combination of a ten-button keypad for manual entry of numeric value data and keyboard for manual entry of character data. The display subsystem 5 visually displays, on a display device 51 such as a liquid crystal display (LCD), various information, controlling states of the CPU 1, etc.

Storage device 71 has stored therein system software similar to server system software per se known from the art and the database managed by the portal server PS. The storage device 71 also has stored therein data related to control of the various programs for execution by the CPU 1. The storage device 71 may be implemented as a hard disk (HD) and/or other storage media, such as any of various removable-type storage media like a compact disc (CD-ROM or CD-R/RW), magneto-optical disk (MO) and digital versatile disk (DVD). The portal server PS is connected to the communication network X via the communication interface 8 to perform communication with any of the information provider terminals PT and information receiver terminals RT and service terminals ST.

The hardware and basic system software of the information provider terminals PT and information receiver terminals RT and service terminals ST may be essentially based on any general purpose personal computer hardware and software and may particularly include a standard operating system (OS) and a standard internet browser. Further, in the inventive system an information provider terminal PT may also function as an information receiver terminal RT or a service terminal ST or both and vice versa.

The system software SYS of the portal server PS includes software modules implementing the following:
means for receiving, via the network X, information from the information provider terminals PT, employing the communication interface 8,
presenting means for presenting, via the network X, to the information receiver terminals RT at least one of the sets of information provider terminal data, employing the communication interface 8,
means for transmitting, via the network X, information to the information receiver terminal RT, employing the communication interface 8, and
means for updating the score data in the database.

In the communication system of FIG. 1 the portal server PS and terminals RT, PT and ST generally function as follows, wherein the method steps performed by the server are implemented using respective modules of the system software SYS. The basic method steps are illustrated in FIG. 3.

In a first step (Step S1), the portal server PS receives information from an information provider terminal PT. When a particular one RT1 of the information receiver terminals RT sends a request for starting an information acquiring process, the portal server PS presents, via a network, to the information receiver terminal RT1 at least one set of information provider terminal data representing the information provider terminals PT and comprising score data indicative of scores alloted to information previously received from the respective information provider terminal PT (Step S2). The portal server PS then enables the information receiver terminal to select a set of information provider terminal data among the presented sets (Step S3) and receives from the information receiver terminal RT1 a specific query for information from the information provider terminal PT1 represented by the selected set of information provider terminal data (Step S4). Then, the server transmits, to the information receiver terminal RT1, a specific information relating to the specific query (Step S5). The user of the information receiver terminal RT1 is then prompted to score the quality of the information provided to the information receiver terminal RT1 (e.g. choose a rating value out of a given range), and the portal server PS receives the respective score. The portal server PS then updates the score data in the selected set of information provider terminal data using the received score (Step S6). Usually, the user of the information receiver terminal RT1 will be charged for the received information in a charging process conducted by the portal server PS.

Payment for delivered information may be processed such that the customer (i.e. the user of the information receiver terminal RT1) transfers an agreed value to a bank account that is accessible by the portal server PS, the portal server PS checks the correctness of the money transfer and finally initializes the transfer of the money to an account associated with the information provider terminal PT1. The portal server's PS role as money transfer mediator is especially then advantageous, if the operator of the information provider terminal PT1 wants to stay anonymous for the customer or vice versa.

It is also possible that the customer pays a definite amount of money to the bank account that is accessible by the portal server PS and therewith acquires a license to receive consulting service of definite value via the system.

Advantageously, the portal server PS may be equipped with identity management software that allows an access controlled storage of information provider terminal data and information receiver terminal data and the respective users' ability to choose an alias name for their public appearance.

Also advantageously, the portal server PS may be equipped with encryption and decryption software for allowing secure data transfer, in particular in connection with processing payments.

Preferably, the portal server PS forces the user of the information receiving terminal RT1 to score the information (i.e. (e.g. choose a rating value out of a given range, representing his satisfaction with the previously provided information), before the information receiving terminal RT1 is able to a again logon to the portal server PS.

The user of the next one of the information receiver terminals RT to which the set of information provider terminal data representing the information provider terminal PT1 is presented will then be able to rely on the updated score data. Thus, the users of information receiver terminals RT seeking a specific information will be able to select an information provider terminal PT (by selecting the information provider terminal data representing the respective information provider terminal PT) for a specific query depending on the score the respective information provider terminal. PT has previously received. In most implementations, the query will be routed, by the portal server PS, to the selected information provider terminal PT, and the selected information provider terminal PT will transmit the requested information to the portal server PS upon receipt of the query. However, the system and method of the present invention are also useful in implementations, wherein the requested information (stemming from the respective information provider terminal PT) is pre-stored on the portal server PS.

In a first implementation, the invention is used in the context of consulting via the internet. This embodiment can be applied to various kinds of consulting such as business consulting, technical support, medical advice, legal counseling etc. Therein, the information receiving terminals RT function as client terminals RT and the information providing terminals function as consultant terminals PT. Thus a system is provided comprising a plurality of client terminals RT and a plurality of consultant terminals PT connected to the network X. The database stores sets of consultant terminal data, wherein each set of consultant terminal data represents a respective consultant terminal PT among the plurality of consultant terminals PT and includes score data indicative of scores alloted, by individual ones of the plurality of client terminals RT, to previous responses received from the respective consultant terminal PT, and presenting means for presenting to the client terminals RT at least one of the sets of consultant terminal data. The consultant terminals comprise means for receiving queries from the portal server PS and means for transmitting, to the portal server PS, responses to the queries. The client terminals RT comprise selecting means for selecting in the portal server server PS via the network X a set of consultant terminal data among the sets of consultant terminal data presented, and inquiring means for transmitting, via the network X, to the portal server PS a specific query designated for the consultant terminal PT1 represented by the selected set of consultant terminal data, receiving means for receiving, via the network X, from the portal server PS a specific response to the specific query, and scoring means for allotting a score to the specific response and transmitting the score to the portal server PS. The portal server further comprises means for forwarding the specific query to the consultant terminal PT1 represented by the selected set of consultant terminal data, means for receiving, from the consultant terminal PT1 represented by said selected set of consultant terminal data, a specific response to the specific query, means for forwarding the specific response to the client terminal RT1 having transmitted the specific query, and means for updating the score data in the selected set of consultant terminal data using the score alloted to the specific response. Again, payment may be processed by the portal server PS.

Thus advantageous use is made of a database DB containing consultant associated ratings that have been entered by customers after having received information from the consultant via the system. Therein, the portal server PS functions as a “general advisor platform”. The scheme according to the present invention that a consultant is building up confidence on an interne platform by published customer ratings can be applied for all kinds of information services.

In a second implementation, the invention is used in the context of patent rights control and trading platform.

Such a platform can be useful to tackle the difficulties that the proprietor of a patent may face to identify infringement somewhere in the protected region, to offer patent licenses, to find a partner who covers patent expenses, to more easily understand the ideas of other patents and to trade with patent rights.

The platform according to the second implementation makes use of the database, the web communication abilities and the payment processing abilities of the inventive system. Therein, different user roles may be dealt with, such as the proprietor or assignee, the inventor, the agent and the common user.

In this context, the present invention is applied in an infringement notification procedure. Based on patent information published by the patent proprietor a so called reporter can advise the proprietor of a patent infringement. Therein, the reporter acts as user of the information provider terminal PT and the patent proprietor acts as user of the information receiver terminal RT.

Initially, the patent proprietor's contact data are entered into the portal server PS via the network X. The patent proprietor is in turn provided with a user ID and password to access the portal server PS in the role of patent proprietor, having the rights to publish his own patent application or granted patent and to communicate with other system users under the published name. The process according to this implementation requires that the patent proprietor to publish data relating to his patented invention on the platform according to a given structure, analogous to structures known from data presentation, e.g., on real estate or car trade platforms. Such a structure may be presented in a screen mask with a drawing field, an abstract field etc. Both the patent proprietor's name and the data relating to the patented invention are thus part of a respective set of information receiver terminal data in the database DB.

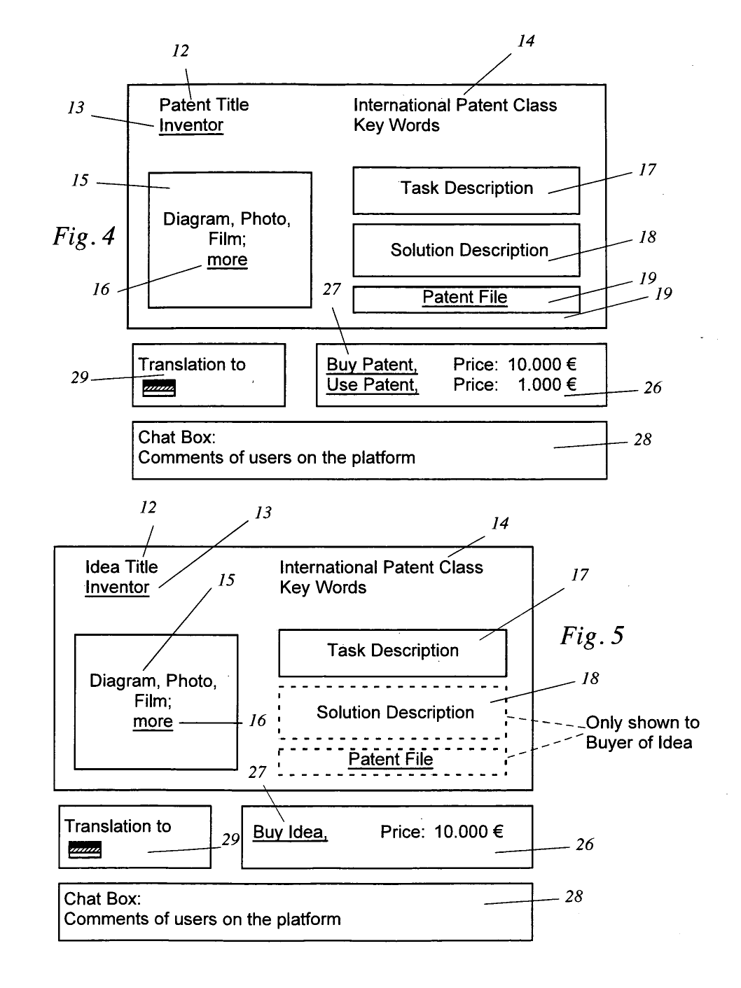

In particular, patent related data comprised in the information receiver terminal data may be presented on the screen of a potential reporter, that is, in the given setup, the display of an information provider terminal PT, in a manner similar as depicted in FIG. 4, partially described in more detail below in connection with other platform functions. A respective screen layout may comprise a descriptive patent title 12, the inventor's or proprietor's name or a clickable hyperlink 13 leading to respective information, and other searchable textual information 14, 17, 18 such as patent class (IPC), keywords, a description of the problem solved by the patented invention as well as a description of the respective solution. The screen layout may further comprise a field 15 with non-textual descriptive information such as diagrams, photographs, video clips and/or a clickable hyperlink 16 leading to respective information, and a clickable hyperlink 19 leading to an online patent file or official patent publication.

The reporter may be close to the infringer from geographical or organizational point of view and may therefore want to stay anonymous. Nevertheless the reporter wants to receive payment for his investigation and information.

At the beginning of an infringement notification process, the reporter enters, via the network X, his contact data like name, address and bank account into the portal server PS. His contact data are especially access protected on the portal server PS and will not be disclosed to anyone, but only used for money transfer to his account. To the patent proprietor the reporter is presented under a self given alias. The alias is thus part of the respective set of information provider terminal data.

The reporter sends a notification to a mailbox assigned to the patent proprietor, indicating that he wants to sell an infringement information, optionally including the price. This notification is thus part of the respective set of information provider terminal data.

The patent proprietor checks the reporter's rating (score) that is presented together with the reporter's alias, wherein the rating relates to the satisfaction of patent proprietor's with the quality of previous notifications by the reporter. In particular, the presented information provider terminal data displayed on the screen of the patent proprietor, that is, in the given setup, the display of an information receiver terminal RT, may comprise a score list similar as depicted in FIG. 7. Therein, a first column 21 may contain a serial number of previous reportings by the respective reporter, a second column 22 may contain information about the technical field in question, such as patent class information (IPC), a third column 23 may comprise the actual respective score, such as a verbal rating or a numerical score (similar to numerical grades in school), a fourth column may indicate the respective price range within which compensation for the respective previous reporting was paid, and fifth column may include a customer reference (either alias or real customer name), allowing the potential new customer (patent proprietor) to refer to. The customer reference may include a clickable hyper link leading to contact information or even initiating a query form to inquire reference information from the respective previous customer.

Depending on the details already given in the initial notification and the reporter's rating the patent proprietor accepts the reporter's price proposal or, if the reporter leaves the price open, puts a price offer into a response to the portal server PS which is forwarded to the information provider terminal PT. It may happen that the reporter initially has to perform for free in order to build up his rating on the platform and therewith the patent proprietors' confidence.

The patent proprietor transfers the agreed value on the bank account controlled by the portal server PS, mentioning the reporter's alias.

The portal server PS transfers the money on to the reporter's registered bank account.

The reporter sends, via the network X, the full information concerning the infringement to the portal server PS, which then forwards the information to the patent proprietor's information receiver terminal RT.

In the course of his next system login, the patent proprietor is prompted to enter a score according to his satisfaction with the reporter's information delivery. Mentioning the patent proprietor's name the rating is added to the respective set of information provider terminal data (such as the data displayed in the list of FIG. 7).

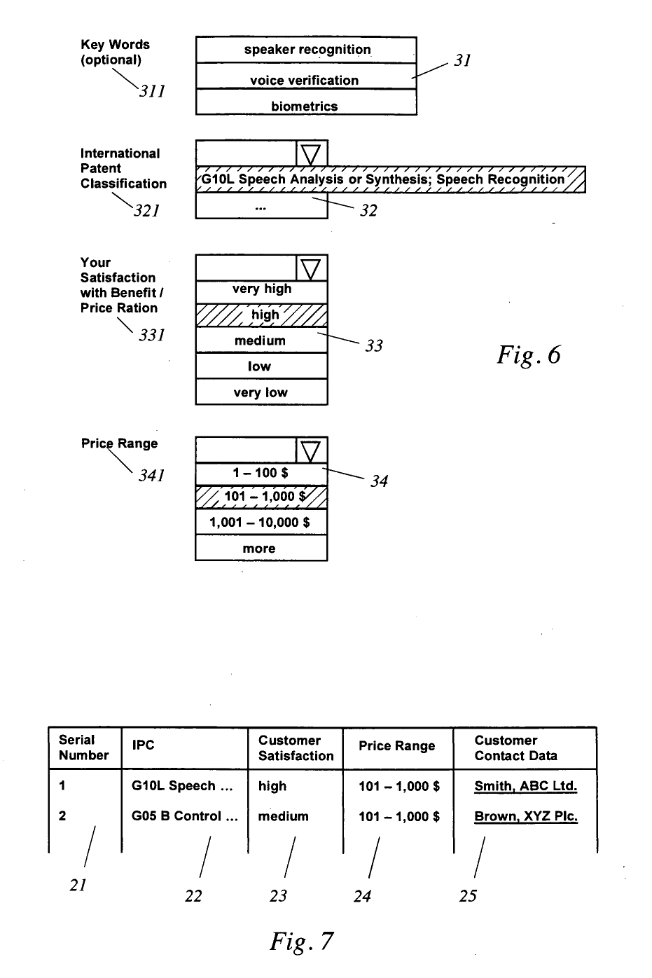

FIG. 6 gives an example of a screen layout for entering the score. Therein, the various fields 31, 32, 33, 34 together with respective field descriptors 311, 321, 331, 341 may be displayed together in one screen layout or one after another. The fields include a text field 31 for optionally entering keywords describing the technical field in question, a selection field 32 for selecting a patent class (IPC) identifier of the technical field in question, a selection field 33 or a number of checkboxes for selecting a score/satisfaction rating (e.g. ration benefit/price), such as “(very) high”, “medium”, “(very) low”, and a selection field 34 for selecting the price range indicating the approximate monetary compensation the reporter has received.

Furthermore, the patent rights control and trading platform may have some or all of the following functions.

a) Publication of own application. The Platform supports the user to properly publish the patented invention or the invention for which a patent is sought, respectively, in a manner differently to the regular publication of patents and patent applications. This may be useful as the presentation can be adapted to the needs of a particular target audience.

The user may select a main drawing that explains the invention. Additional graphics can be uploaded. In addition to figures taken from the respective patent application, the user may upload color photos of objects for which protection is sought or create three dimensional or even animated graphics to demonstrate his idea. The Platform may support the user by offering commercial support from design agencies operating service terminals ST connected to the network X as depicted in FIG. 1.

The respective design agency may help with the graphics in an online process, wherein the respective service terminal ST is connected with the patent proprietor's information receiver terminal RT via the portal server PS in a web phone conference. A symbol such as a green light may indicate that a service terminal ST is currently available. Another symbol such as a red light may indicate that the user may fix a time window with the agency operating the respective service terminal ST. The user may track and direct the agency's work online. Finally, the user evaluates his satisfaction/cost-performance-ratio regarding the agency's work. The portal server PS uses the feedback to update a respective set of service terminal data stored in the database. Different design agencies can thus compete in a transparent manner.

The platform may further support the user (i.e. patent proprietor) by offering drawing tools on the platform, by which the user can create his own graphics.

Service terminals ST may further be utilized to offer a text design and translation service that shall make the patented invention available and appealing to a certain target audience. Contrary to the text of a patent application such a text can be tailored focussing on being informative rather than focussing on legal implications.

Text design and translation may be provided analogously to the above mentioned graphic design service by associated, competing agencies that are rated by their customers.

Payment to agencies may be processed by the portal server PS. The services “graphic design” and “text design and translation” may be priced per minute. The user may limit the expense to a maximum value. An extra window may display the consumed time and/or money.

b) Share opinions functions. The platform may make use of interactive and collaborative web 2.0 technologies to support a community life, such as expert chats within certain industry sectors/IPC classes. Participant groups may be: patent investors, patent agencies, inventors, product managers, universities etc.

A patent proprietor may allow the platform community, i.e. terminals RT, PT, ST connected to the network X, to rate or comment on the Platform specific publication (graphics, translation) of his patent idea.

Likewise, a patent proprietor may allow the platform community, i.e. terminals RT, PT, ST connected to the network X, to rate or comment on this patent idea itself.

Further, a registered platform user may announce that he has found a solution for a described task and offers the idea—that for any reason is not predestined for a patent—for a certain price. The user's terminal then functions as an information provider terminal PT. Depending on the score data in the respective set of information provider terminal data (including, e.g.: customer name, industry sector/IPC class, cost performance ratio rating), that this user has build up from previous idea sales, the user may achieve a certain price level.

c) Image comparison. The platform may further provide an image comparison tool which may be centrally hosted on the portal server PS or hosted on a service terminal ST. The platform enables the user to upload photos or drawings of devices that may infringe a patent published on the platform. The image comparison tool compares the uploaded graphic with the graphics stored in the database DB or in external patent database. The search scope may be limited, e.g. to certain IPC classes. The described mechanism helps identifying patent infringements.
d) IP Trading. A private inventor who lacks the budget to carry an invention through patenting may publish his invention via the platform, together with an expected price for sale or license. Likewise, a patent proprietor may publish his invention via the platform, together with an expected price for sale or license. For entering such data on the IP proprietor's screen as well as for displaying such data on the screens of potential buyers or licensees, a screen layout like the one depicted in FIG. 4 may be used. In addition to the fields described above, a field 26 indicating suggested prices for purchasing the patent or royalty fees for licensing the patent may be provided. Further, hyperlinks 27 for initiating a purchasing or licensing procedure may be provided. Further a field 28 for above share opinions functions, such as a text message or chat function, may be provided as well as a selection field 29 for accessing a translation service provided by a service terminal ST or a machine translation.

For the purposes of IP trading, the platform may also provide an auction function, wherein the inventor or patent proprietor sets minimum and transfers the respective rights to the best bidding user.

e) Patent search. Since the inventors and patent proprietors use the Platform to share their ideas with others, they are especially motivated to describe the respective invention in simple and commonly understandable terms. Classification and a search engine that may be installed on the portal server PS as part of the platform can help users to retrieve the sought for patent information on the platform.
f) Idea promotion. The platform may also be useful to persons having an idea that might be patented, but not having enough money for applying for a patent. Such persons can act as users of information provider terminals PT. The presented set of information provider terminal data may then include pre-information (such as IPC) of the idea, a minimum sale price, a score relating to previous customers' satisfaction with idea purchases, prior deal volume ranges etc. The person may also publish on the platform his curriculum vitae and certificates that indicate his competence on the field of the offered idea.

For entering such data on the idea provider's screen as well as for displaying such data on the screens of potential buyers, a screen layout like the one depicted in FIG. 5 may be used. The screen layout is similar as in FIG. 4 with corresponding reference numerals relating to corresponding features.

Field 17 contains textual information describing the problem the idea on sale helps to solve. Field 26 indicates a price for purchasing the idea. Further, a hyperlinks 27 for initiating a purchasing procedure may be provided. The non textual information field 15 may be hidden until the idea has actually been purchased, depending on how revealing the non textual information (graphics, video etc.) is. A textual description of the idea in field 18 is hidden until the idea has been purchased and, after the purchase, is shown only to the respective buyer. The same applies to a hyperlink for opening a file describing the idea in more detail.

What is claimed is:

1. A communication system comprising
a) a network,
b) a plurality of information receiver terminals connected to said network
c) a plurality of information provider terminals connected to said network, and
d) a server connected to said network, said server comprising means for receiving information from said information provider terminals, a database storing sets of information provider terminal data, wherein each set of information provider terminal data represents a respective information provider terminal among said plurality of information provider terminals and includes score data indicative of scores alloted, by individual ones of said plurality of information receiver terminals, to information previously received from the respective information provider terminal, and presenting means for presenting to said information receiver terminals at least one of said sets of information provider terminal data;
wherein said information provider terminals each comprise means for transmitting, via said network, information to said server;
said information receiver terminals each comprise inquiring means for selecting in said server, via said network, a set of information provider terminal data among said sets of information provider terminal data presented and transmitting, via said network, to said server a specific query for information from the information provider terminal represented by said selected set of information provider terminal data, receiving means for receiving, via said network, from said server a specific information relating to said specific query, and scoring means for allotting a score to said specific information and transmitting said score to said server; and
said server further comprises means for transmitting said specific information to the information receiver terminal having transmitted said specific query, and means for updating the score data in said selected set of information provider terminal data using the score alloted to said specific information.

2. The communication system according to claim 1, wherein
said server further comprises means for forwarding said specific query to the information provider terminal represented by said selected set of information provider terminal data, and
said information provider terminals further comprise means for receiving queries from said server.

3. The communication system according to claim 1, wherein, after having transmitted, to an individual one among said plurality of information receiver terminals, a specific information relating to a specific query transmitted by said individual information receiver terminal, said server requires said individual information receiver terminal to transmit said score allotted to said specific information, before allowing another specific information to be transmitted to said individual information receiver terminal.

4. The communication system according to claim 1, wherein said database further stores sets of information receiver terminal data, wherein each set of information receiver terminal data represents a respective information receiver terminal among said plurality of information receiver terminals, and
said presenting means are further adapted to present to said information provider terminals at least one of said sets of information receiver terminal data.

5. The communication system according to claim 4, wherein said information receiver terminals comprise upload means for uploading, via said network, data to said server, and
said server is adapted to selectively allow upload of data from an individual one among said plurality of information receiver terminals in order to modify the respective set of information receiver terminal data representing said individual information receiver terminal.

6. The communication system according to claim 5, further comprising at least one service terminal connected to said network, said at least one service terminal comprising means for processing receiver terminal data,
wherein said database further stores at least one set of service terminal data, each set of service terminal data representing a respective one of said at least one service terminals,
said presenting means is further adapted for presenting, to said information receiver terminals, at least one of said sets of service terminal data,
said server further comprises means for allowing an individual one among said plurality of information receiver terminals to select a set of service terminal data from said presented sets of service terminal data, means for receiving from said individual information receiver terminal a specific service request, means for forwarding said specific service request to the service terminal represented by said selected set of service terminal data, and
said server is further adapted to allow the service terminal represented by said selected set of service terminal data to process, according to said specific service request, data in the set of information receiver terminal data representing said individual information receiver terminal.

7. The communication system according to claim 1, wherein said server comprises access management means for allowing, controlling and denying connections between said information receiver terminals and said server and between said information providing terminals and said server.

8. The communication system according to claim 7, wherein said server is adapted to selectively forward, via said network, messages from said information provider terminals to said information receiver terminals and from said information receiver terminals to said information provider terminals.

9. The communication system according to claim 1, wherein each of said server, said information receiver terminals and said information provider terminals comprise encryption means and decryption means for allowing encrypted data transfer between said server and said information receiver terminals and between said server and said information provider terminals.

10. The communication system according to claim 1, wherein said server comprises payment processing means for processing payments received from clients associated with information receiver terminals having received information from said server.

11. A communication server comprising
a) means for receiving information from information provider terminals,
b) a database for storing a plurality of sets of information provider terminal data, each set of information provider terminal data representing a respective information provider terminal and comprising score data indicative of scores alloted to information previously received from the respective information provider terminal,
c) means for presenting, via a network, to an information receiver terminal at least one set of said plurality of sets of information provider terminal data,
d) means for selecting, in accordance with a selection process of said information receiver terminal, a set of information provider terminal data among said sets of information provider terminal data presented,
e) means for receiving, via said network, from said information receiver terminal a specific query for information from the information provider terminal represented by said selected set of information provider terminal data,
f) means for transmitting, to the information receiver terminal, a specific information relating to said specific query, and
g) means for updating the score data in said selected set of information provider terminal data using a score alloted by said information receiver terminal to said specific information.

12. The communication server according to claim 11, further comprising means for forwarding said specific query to the information provider terminal represented by said selected set of information provider terminal data.

13. The communication server according to claim 11, wherein said database further stores information receiver terminal data representing said information receiver terminal, and said presenting means are further adapted to present to said information provider terminals said information receiver terminal data.

14. The communication server according to claim 13, wherein said server is adapted to selectively allow upload of data from said information receiver terminal in order to modify the receiver terminal data representing said information receiver terminal.

15. The communication server according to claim 11, wherein said database further stores at least one set of service terminal data, each set of service terminal data representing a respective service terminal,
said presenting means is further adapted for presenting, to said information receiver terminal, at least one of said sets of service terminal data,
said server further comprises means for allowing said information receiver terminal to select a set of service terminal data from said presented sets of service terminal data, means for receiving from said information receiver terminal a specific service request, means for forwarding said specific service request to the service terminal represented by said selected set of service terminal data, and
said server is further adapted to allow the service terminal represented by said selected set of service terminal data to process, according to said specific service request, said receiver terminal data representing said information receiver terminal.

16. The communication server according to claim 11, wherein said server comprises access management means for allowing, controlling and denying connections between said information receiver terminal and said server and between said information providing terminals and said server.

17. The communication system according to claim 16, wherein said server is adapted to selectively forward, via said network, messages from said information provider terminals to said information receiver terminal and from said information receiver terminal to said information provider terminals.

18. The communication server according to claim 11, further comprising encryption means and decryption means for allowing encrypted data transfer between said server and said information receiver terminal and between said server and said information provider terminals.

19. The communication server according to claim 11, wherein said server comprises payment processing means for processing payments received from a client associated with the information receiver terminal.

20. A communication server method comprising the following steps
a) receiving information from an information provider terminal,
b) presenting, via a network, to an information receiver terminal at least one set of information provider terminal data representing a respective information provider terminal and comprising score data indicative of scores alloted to information previously received from the respective information provider terminal,
c) selecting, in accordance with a selection process of said information receiver terminal, a set of information provider terminal data among said sets of information provider terminal data presented,
d) receiving, via said network, from said information receiver terminal a specific query for information from the information provider terminal represented by said selected set of information provider terminal data,
e) transmitting, to the information receiver terminal, a specific information relating to said specific query, and
f) updating the score data in said selected set of information provider terminal data using a score alloted by said information receiver terminal to said specific information.

21. The communication method of claim 20, further comprising the step of forwarding said specific query to the information provider terminal represented by said selected set of information provider terminal data,
wherein said step of receiving information from an information provider terminal includes receiving said specific information in response to said step of forwarding said specific query to the information provider terminal represented by said selected set of information provider terminal data.
